(19) United States
(12) Patent Application Publication
(10) Pub. No.: US 2009/0006910 A1
(43) Pub. Date: Jan. 1, 2009

(54) SELECTIVE HYBRID ARQ

(76) Inventor: Belal Hamzeh, Beaverton, OR (US)

Correspondence Address: COOL PATENT, P.C.;c/o INTELLEVATE, P.O. BOX 52050, MINNEAPOLIS, MN, 55402, US

(21) Appl. No.: 11/769,585

(22) Filed: Jun. 27, 2007

(51) Int. Cl. G06F 11/00; H04L 1/18

(52) U.S. Cl. 714/704; 714/748; 714/E11.141; 714/E11.004

(57) ABSTRACT

Briefly, in accordance with one or more embodiments, a HARQ process may be selectively executed according to longer term and/or shorter term packet error rate statistics to be within one or more requirements of an application. As result, the number of retransmissions for the HARQ process may be reduced or minimized.

### BACKGROUND

Automatic Repeat Request (ARQ) is a technique for error control in communication systems utilizing acknowledgments and timeouts. If the transmitter does not receive an acknowledgment before a timeout, the then data is retransmitted until correctly received or after a predetermined number of retransmissions. Hybrid ARQ (HARQ) is also used as an error control method, in which an error detection code is added to data packets prior to transmission, giving better performance than ARQ over broadband channels. If the receiver cannot decode the error detection code, then retransmission is requested. The multiple variations of HARQ, for example HARQ I, HARQ II, or HARQ III, require retransmissions of redundant information in the event the receiver fails to decode packets correctly. The retransmission process is applied on a per link basis over all transmissions, and serves to guarantee data integrity with lower latency than what would be achieved by using ARQ.

For lossless applications such as file transfer protocol (FTP), web browsing, and so on, 100% data integrity is typically specified, and as a result the success of the HARQ process may be critical to the application functionality to minimize latency. In loss-tolerant applications such as voice over internet protocol (VoIP), video, and so on, 100% data integrity is not needed due to the nature of the application and the loss concealment mechanisms embedded into the application. Nonetheless, such applications may have a maximum value for short term and long term Packet Error Rate (PER) which the communication link should guarantee, and beyond which the application quality may be deemed unacceptable. In such a circumstance the user may be considered in outage.

Conventional HARQ operates on a per packet basis without considering application requirements or the short term and long term statistics of the link. Such an approach is resource extensive and may not be optimized for application requirements or application capabilities, thereby causing inefficient usage of system resources.

### DESCRIPTION OF THE DRAWING FIGURES

Claimed subject matter is particularly pointed out and distinctly claimed in the concluding portion of the specification. However, such subject matter may be understood by reference to the following detailed description when read with the accompanying drawings in which:

FIG. 1 is a block diagram of a wireless network capable of utilizing selective hybrid ARQ in accordance with one or more embodiments;

FIG. 2 is a block diagram of a system capable of utilizing selective hybrid ARQ logic in a link layer in accordance with one or more embodiments;

FIG. 3 is flow diagram of a method for implementing selective hybrid ARQ in accordance with one or more embodiments;

FIG. 4 is a block diagram of a wireless local area or cellular network communication system showing one or more network devices capable of utilizing selective hybrid ARQ in accordance with one or more embodiments; and

FIG. 5 is a block diagram of an information handling system capable of capable of utilizing selective hybrid ARQ in accordance with one or more embodiments.

It will be appreciated that for simplicity and/or clarity of illustration, elements illustrated in the figures have not necessarily been drawn to scale. For example, the dimensions of some of the elements may be exaggerated relative to other elements for clarity. Further, if considered appropriate, reference numerals have been repeated among the figures to indicate corresponding and/or analogous elements.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

In the following description and/or claims, the terms coupled and/or connected, along with their derivatives, may be used. In particular embodiments, connected may be used to indicate that two or more elements are in direct physical and/or electrical contact with each other. Coupled may mean that two or more elements are in direct physical and/or electrical contact. However, coupled may also mean that two or more elements may not be in direct contact with each other, but yet may still cooperate and/or interact with each other. For example, “coupled” may mean that two or more elements do not contact each other but are indirectly joined together via another element or intermediate elements. Finally, the terms “on,” “overlying,” and “over” may be used in the following description and claims. “On,” “overlying,” and “over” may be used to indicate that two or more elements are in direct physical contact with each other. However, “over” may also mean that two or more elements are not in direct contact with each other. For example, “over” may mean that one element is above another element but not contact each other and may have another element or elements in between the two elements. Furthermore, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect. In the following description and/or claims, the terms “comprise” and “include,” along with their derivatives, may be used and are intended as synonyms for each other.

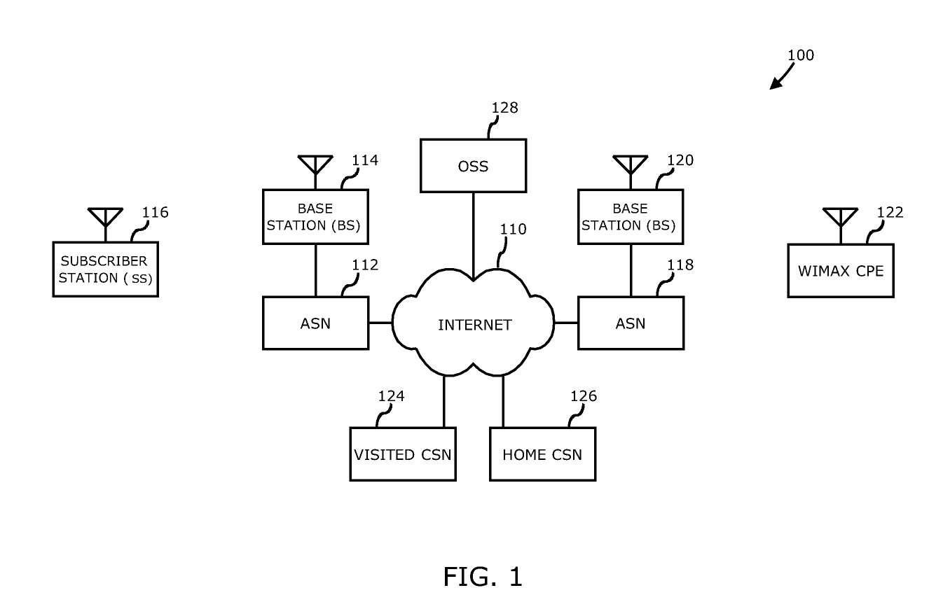

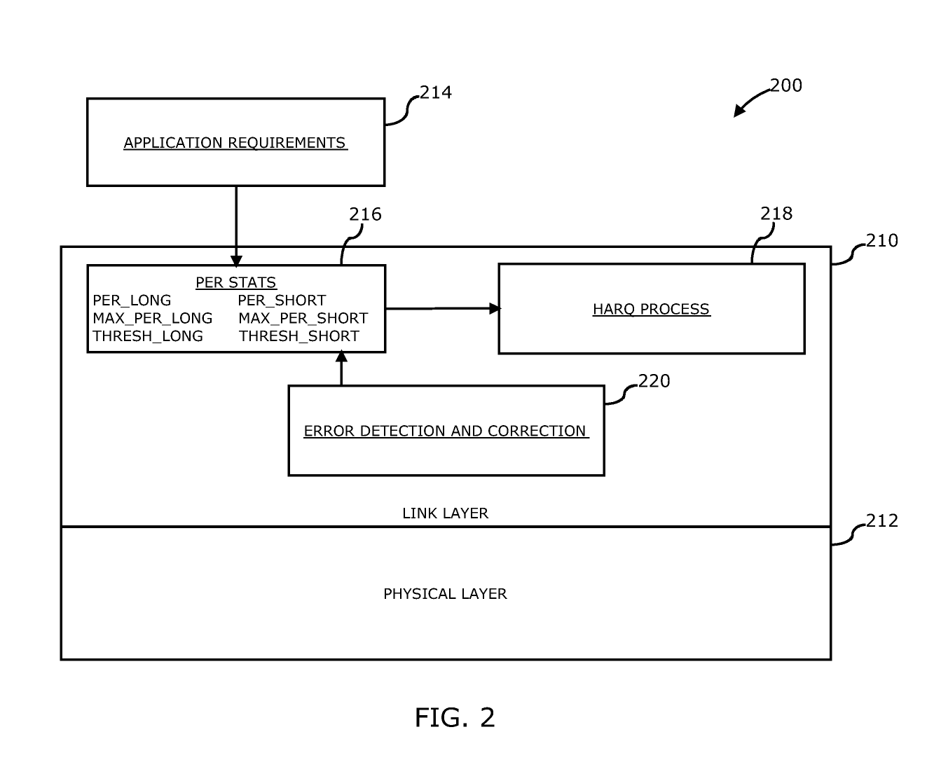

Referring now to FIG. 1, a block diagram of a wireless network capable of utilizing selective hybrid ARQ in accordance with one or more embodiments will be discussed. In one or more embodiments, any one or more of base station 114, subscriber station 116, base station 122, and/or WiMAX customer premises equipment (CPE) 122 may utilize the system 200 of FIG. 2, below, capable of utilizing selective hybrid ARQ logic in a link layer, although the scope of the claimed subject matter is not limited in this respect. As shown in FIG. 1, network 100 may be an internet protocol (IP) type network comprising an internet 110 type network or the like that is capable of supporting mobile wireless access and/or fixed wireless access to internet 110. In one or more embodiments, network 100 may be in compliance with a Worldwide Interoperability for Microwave Access (WiMAX) standard or future generations of WiMAX, and in one particular embodiment may be in compliance with an Institute for Electrical and Electronics Engineers 802.16e standard (IEEE 802.16e). In one or more alternative embodiments network 100 may be in compliance with a Third Generation Partnership Project Long Term Evolution (3GPP LTE) or a 3GPP2 Air Interface Evolution (3GPP2 AIE) standard. In general, network 100 may comprise any type of orthogonal frequency division multiple access (OFDMA) based wireless network, although the scope of the claimed subject matter is not limited in these respects. As an example of mobile wireless access, access service network (ASN) 112 is capable of coupling with base station (BS) 114 to provide wireless communication between subscriber station (SS) 116 and internet 110. Subscriber station 116 may comprise a mobile type device or information handling system capable of wirelessly communicating via network 100, for example a notebook type computer, a cellular telephone, a personal digital assistant, or the like. ASN 112 may implement profiles that are capable of defining the mapping of network functions to one or more physical entities on network 100. Base station 114 may comprise radio equipment to provide radio-frequency (RF) communication with subscriber station 116, and may comprise, for example, the physical layer (PHY) and media access control (MAC) layer equipment in compliance with an IEEE 802.16e type standard. Base station 114 may further comprise an IP backplane to couple to internet 110 via ASN 112, although the scope of the claimed subject matter is not limited in these respects.

Network 100 may further comprise a visited connectivity service network (CSN) 124 capable of providing one or more network functions including but not limited to proxy and/or relay type functions, for example authentication, authorization and accounting (AAA) functions, dynamic host configuration protocol (DHCP) functions, or domain name service controls or the like, domain gateways such as public switched telephone network (PSTN) gateways or voice over internet protocol (VOIP) gateways, and/or internet protocol (IP) type server functions, or the like. However, these are merely example of the types of functions that are capable of being provided by visited CSN or home CSN 126, and the scope of the claimed subject matter is not limited in these respects. Visited CSN 124 may be referred to as a visited CSN in the case for example where visited CSN 124 is not part of the regular service provider of subscriber station 116, for example where subscriber station 116 is roaming away from its home CSN such as home CSN 126, or for example where network 100 is part of the regular service provider of subscriber station but where network 100 may be in another location or state that is not the main or home location of subscriber station 116. In a fixed wireless arrangement, WiMAX type customer premises equipment (CPE) 122 may be located in a home or business to provide home or business customer broadband access to internet 110 via base station 120, ASN 118, and home CSN 126 in a manner similar to access by subscriber station 116 via base station 114, ASN 112, and visited CSN 124, a difference being that WiMAX CPE 122 is generally disposed in a stationary location, although it may be moved to different locations as needed, whereas subscriber station may be utilized at one or more locations if subscriber station 116 is within range of base station 114 for example. In accordance with one or more embodiments, operation support system (OSS) 128 may be part of network 100 to provide management functions for network 100 and to provide interfaces between functional entities of network 100. Network 100 of FIG. 1 is merely one type of wireless network showing a certain number of the components of network 100 that are capable of utilizing a system capable of utilizing selective hybrid ARQ logic in a link layer as shown in FIG. 2, below, and the scope of the claimed subject matter is not limited in these respects.

Although network 100 as shown in FIG. 1 is a WiMAX network as an example, it should be noted that system 200 of FIG. 2, below may be utilized in other types of wireless networks and/or applications utilizing wideband orthogonal frequency division multiplexing (OFDM) modulation, however system 200 is not limited to OFDM modulation or OFDMA as system 200 may be access scheme independent and can be likewise applied to code division multiple access (CDMA) schemes, wideband code division multiple access (WCDMA) schemes, and so on, and the scope of the claimed subject matter is not limited in these respects. For example, in one or more embodiments, network 100 alternately may comprise a network in compliance with an Institute of Electrical and Electronics Engineers (IEEE) standard such as an IEEE 802.11 a/b/g/n standard, an IEEE 802.16 d/e standard, an IEEE 802.20 standard, an IEEE 802.15 standard, an Ultra-Wide Band (UWB) standard, a Third Generation Partnership Project Long Term Evolution (3GPP-LTE) standard, an Enhanced Data Rates for Global System for Mobile Communications (GSM) Evolution (EDGE) standard, a Wideband Code Division Multiple Access (WCDMA) standard, a Digital Video Broadcasting (DVB) standard, or the like, and the scope of the claimed subject matter is not limited in this respect.

Referring now to FIG. 2, a block diagram of a system capable of utilizing selective hybrid ARQ logic in a link layer in accordance with one or more embodiments will be discussed. As shown in FIG. 2, in one or more embodiments system 200 may implement selective hybrid ARQ (SHARQ) logic in the link layer 210 just above the physical layer 212 in accordance with the Open System Interconnection (OSI) Reference Model. System 200 may receive application requirements 214 which may include one or more packet error rate (PER) parameters. During operation of system 200, one or more link statistics such as PER statistics may be monitored and stored via link statistics logic circuit (PER_STATS) 216, and which may include, for example, a longer term packet error rate (PER_LONG), a shorter term packet error rate (PER_SHORT), a maximum longer term packet error rate (MAX_PER_LONG), a maximum shorter term packet error rate (MAX_PER_SHORT), a threshold longer term packet error rate (THRESH_LONG), and/or a threshold shorter term packet error rate (THRESH_SHORT). In one or more embodiments, system 200 implements SHARQ to provide a dynamic control method for initiating HARQ processes based at least in part on application requirements 214 and link statistics maintained in link statistics logic circuit 216. In SHARQ, the shorter term and longer term PER statistics are monitored and compared to the application requirements 214, and a HARQ process may be initiated selectively in order to maintain the shorter term and/or longer term PER statistics within application requirements 214. In one or more embodiments, not all erroneous packets initiate a HARQ process, and the scope of the claimed subject matter is not limited in this respect. In one or more embodiments, application requirements 216 may be based at least in part on the type of application for which system 200 is receiving packets. For example, if the application is a voice over internet protocol (VOIP) type application, THRESH_SHORT may comprise a 4% packet error rate, and THRESH_LONG may comprise a 15% packer error rate. In another embodiment, the threshold may be based at least in part on a time parameter. In the VOIP example, THRESH_SHORT may comprise 0.5 second in which a packet may be dropped, and THRESH_LONG ma comprise the duration of the call. However, these are merely examples for application requirements 214, and the scope of the claimed subject matter is not limited in these respects.

In one or more embodiments, if an erroneous packet arrives at the receiver in which system 200 is disposed, the shorter term and/or longer term PER statistics are updated and compared to the shorter term and/or longer term threshold values for the PER statistics. The threshold values may be based at least in part on application requirements 214 and are less than the maximum allowable shorter term and/or longer term PER statistics. If the shorter term and/or longer term PER statistics are within the threshold values, then the packet is Acknowledged (ACK), and the erroneous packet may be discarded without initiating a HARQ process. If the shorter term and/or longer term PER statistics are not within the threshold values, then the packet is Negatively Acknowledged (NACK), and a HARQ process may be initiated.

In one or more embodiments, to implement such a SHARQ process, the link statistics logic circuit (PER_STATS) 216 may be implemented in the link layer 210 between application requirements 214, HARQ process logic circuit 218, and error detection and correction logic circuit 220. In one or more embodiments, PER_SHORT and PER_LONG contain shorter term and longer term PER statistics of the link, respectively, while MAX_PER_LONG and MAX_PER_SHORT contain the upper bound longer term and shorter term PER, where the upper bound PER values define the upper limit of acceptable PER before the application is considered in outage, that is below acceptable quality. THRESH_LONG and THRESH_SHORT take values between 0 and MAX_PER_LONG and MAX_PER_SHORT respectively, and establish the critical threshold for a higher probability of outage. However, these are merely examples of types of link statistics that may be monitored and maintained by system 200, and the scope of the claimed subject matter is not limited in these respects.

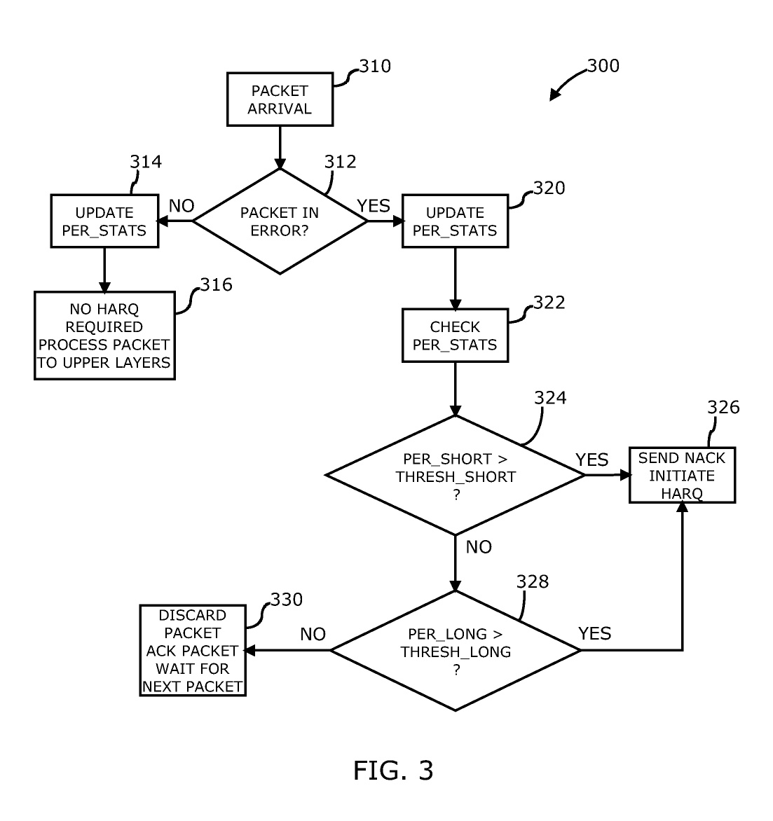

In one or more embodiments, link statistics logic circuit (PER_STATS) 216 is updated on a per packet basis for the monitored link, and HARQ process logic circuit 218 is initiated based on the link statistics given by PER_LONG and/or PER_SHORT, with a goal of maintaining shorter and/or longer term PER statistics below the threshold values, THRESH_LONG and/or THRESH_SHORT. In the event of the arrival of a packet with error, the values of PER_LONG and/or PER_SHORT are checked. If PER_LONG is greater than or equal to THRESH_LONG or if PER_SHORT greater than or equal to THRESH_SHORT, then the application may be deemed to be at a higher risk of unacceptable quality and user outage, so the packet is negatively acknowledged (NACKed) and a HARQ process may be initiated via HARQ process logic circuit 218. If PER_LONG is less than THRESH_LONG, and PER_SHORT<THRESH_SHORT, then the application may be deemed to be in a good condition with a good quality, so the packet is acknowledged (ACKed), and a HARQ process is not initiated. Further description of the flow of such a process is described with respect to FIG. 3, below.

Referring now to FIG. 3, a flow diagram of a method for implementing selective hybrid ARQ in accordance with one or more embodiments will be discussed. Although FIG. 3 shows one particular order of the blocks of method 300, method 300 is not limited to any particular order of the blocks, and may further include more or fewer blocks than shown in FIG. 3. Furthermore, although method 300 is directed to a method of monitoring PER statistics, other statistics regarding the communication link may be monitored to implement a selective hybrid ARQ (SHARQ) process, and the scope of the claimed subject matter is not limited in these respects.

In one or more embodiments, method 300 may be implemented by link statistics logic circuit (PER_STATS) 216 of FIG. 2. A packet may arrive at a receiver at block 310. A determination may be made at decision block 312 whether the packet was received with error. In the even the packet was not received with error, link statistics logic circuit (PER_STATS) 216 may be updated accordingly at block 314, and no HARQ process may be required such at the received packet may be processed by the upper layers of the OSI Reference Model at block 316. In the event the packet was received with error as determined at decision block 312, link statistics logic circuit (PER_STATS) 216 may be updated accordingly at block 320, and the link statistics (PER_STATS) may be checked at block 322 based at least in part on the receipt of a packet with error. A determination may be made at decision block 324 whether the updated shorter term PER statistic (PER_SHORT) is greater than and/or equal to the threshold value for shorter term PER (THRESH_SHORT). If so, then a negative acknowledgment (NACK) may be sent back to the transmitter and a HARQ process may be initiated at block 326. However, if the updated shorter term PER statistic (PER_SHORT) is not greater than and/or equal to the threshold value for shorter term PER (THRESH_SHORT), then a determination may be made at decision block 328 whether the updated longer term PER statistic (PER_LONG) is greater than and/or equal to the threshold value for longer term PER (THRESH_LONG). If so, then a negative acknowledgment (NACK) may be sent back to the transmitter and a HARQ process may be initiated at block 326. However, if the updated longer term PER statistic (PER_LONG) is not greater than and/or equal to the threshold value for longer term PER (THRESH_LONG), then the packet may be discarded, an acknowledgment packet may be sent back to the transmitter, and the receiver may wait for the next packet at block 330. It should be noted that although method 300 of FIG. 3 shows the shorter term statistics being compared to a threshold value the longer term statistics are compared to a threshold value, the order may be reversed where the longer term statistics are compared to a threshold value before the shorter term statistics are compared to a threshold value, and the scope of the claimed subject matter is not limited in this respect.

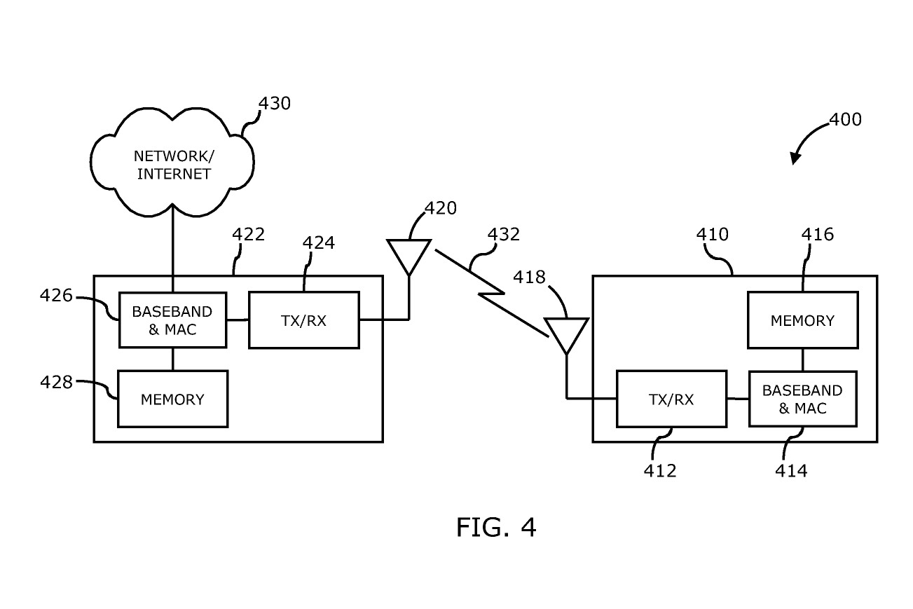

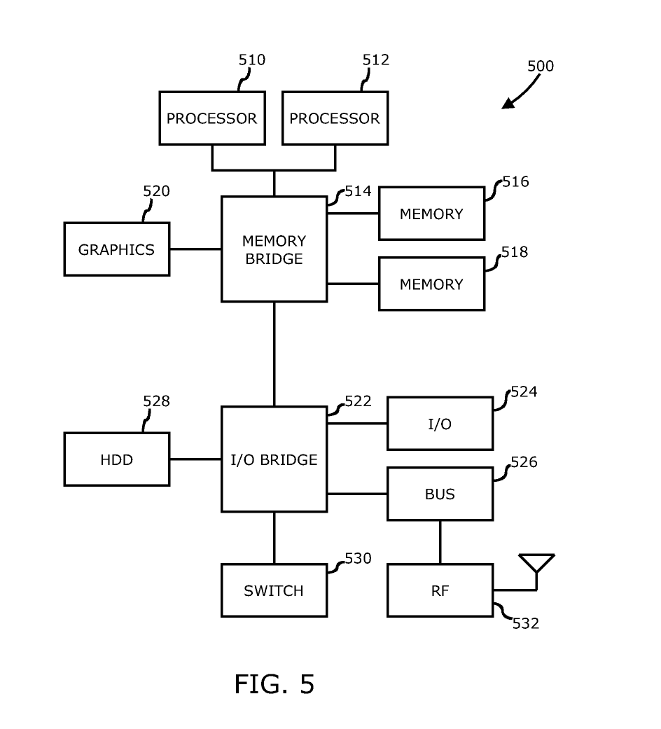

Using a SHARQ method such as method 300 of FIG. 3, the number of HARQ retransmissions may be reduced while maintaining application quality, thereby increasing system resource availability which in turn may increase system capacity such as the capacity of network 100 of FIG. 1. Additionally, a reduction of the number of transmissions and/or receptions may in turn reduce the power consumption at the client device and thereby increase battery life. In one or more embodiments, SHARQ method 300 of FIG. 3 may be potentially utilized in cellular telephones, digital video broadcasting (DVB-H) devices, wireless mobile devices capable of supporting voice and/or video applications, WiMAX devices and/or 3G cards, for example as shown in and described with respect to FIG. 4 and/or FIG. 5, below.

Referring now to FIG. 4, a block diagram of a wireless local area or cellular network communication system showing one or more network devices in accordance with one or more embodiments will be discussed. In the communication system 400 shown in FIG. 4, a mobile unit 410 may include a wireless transceiver 412 to couple to an antenna 418 and to a processor 414 to provide baseband and media access control (MAC) processing functions. In one or more embodiments, mobile unit 410 may be a cellular telephone or an information handling system such as a mobile personal computer or a personal digital assistant or the like that incorporates a cellular telephone communication module, although the scope of the claimed subject matter is not limited in this respect. Processor 414 in one embodiment may comprise a single processor, or alternatively may comprise a baseband processor and an applications processor, although the scope of the claimed subject matter is not limited in this respect. Processor 414 may couple to a memory 416 which may include volatile memory such as dynamic random-access memory (DRAM), non-volatile memory such as flash memory, or alternatively may include other types of storage such as a hard disk drive, although the scope of the claimed subject matter is not limited in this respect. Some portion or all of memory 416 may be included on the same integrated circuit as processor 414, or alternatively some portion or all of memory 416 may be disposed on an integrated circuit or other medium, for example a hard disk drive, that is external to the integrated circuit of processor 414, although the scope of the claimed subject matter is not limited in this respect.

Mobile unit 410 may communicate with access point 422 via wireless communication link 432, where access point 422 may include at least one antenna 420, transceiver 424, processor 426, and memory 428. In one embodiment, access point 422 may be a base station of a cellular telephone network, and in an alternative embodiment, access point 422 may be a an access point or wireless router of a wireless local or personal area network, although the scope of the claimed subject matter is not limited in this respect. In an alternative embodiment, access point 422 and optionally mobile unit 410 may include two or more antennas, for example to provide a spatial division multiple access (SDMA) system or a multiple input, multiple output (MIMO) system, although the scope of the claimed subject matter is not limited in this respect. Access point 422 may couple with network 430 so that mobile unit 410 may communicate with network 430, including devices coupled to network 430, by communicating with access point 422 via wireless communication link 432. Network 430 may include a public network such as a telephone network or the Internet, or alternatively network 430 may include a private network such as an intranet, or a combination of a public and a private network, although the scope of the claimed subject matter is not limited in this respect. Communication between mobile unit 410 and access point 422 may be implemented via a wireless local area network (WLAN), for example a network compliant with a an Institute of Electrical and Electronics Engineers (IEEE) standard such as IEEE 802.11a, IEEE 802.11b, HiperLAN-II, and so on, although the scope of the claimed subject matter is not limited in this respect. In another embodiment, communication between mobile unit 410 and access point 422 may be at least partially implemented via a cellular communication network compliant with a Third Generation Partnership Project (3GPP or 3G) standard, although the scope of the claimed subject matter is not limited in this respect. In one or more embodiments, antenna 418 may be utilized in a wireless sensor network or a mesh network, although the scope of the claimed subject matter is not limited in this respect.

Referring now to FIG. 5, a block diagram of an information handling system capable of capable of utilizing selective hybrid ARQ in accordance with one or more embodiments. Information handling system 500 of FIG. 5 may tangibly embody one or more of any of the network elements of network 100 as shown in and described with respect to FIG. 1. For example, information handling system 500 may represent the hardware of base station 114 and/or subscriber station 116, with greater or fewer components depending on the hardware specifications of the particular device or network element. Although information handling system 500 represents one example of several types of computing platforms, information handling system 500 may include more or fewer elements and/or different arrangements of elements than shown in FIG. 5, and the scope of the claimed subject matter is not limited in these respects.

Information handling system 500 may comprise one or more processors such as processor 510 and/or processor 512, which may comprise one or more processing cores. One or more of processor 510 and/or processor 512 may couple to one or more memories 516 and/or 518 via memory bridge 514, which may be disposed external to processors 510 and/or 512, or alternatively at least partially disposed within one or more of processors 510 and/or 512. Memory 516 and/or memory 518 may comprise various types of semiconductor based memory, for example volatile type memory and/or non-volatile type memory. Memory bridge 514 may couple to a graphics system 520 to drive a display device (not shown) coupled to information handling system 500.

Information handling system 500 may further comprise input/output (I/O) bridge 522 to couple to various types of I/O systems. I/O system 524 may comprise, for example, a universal serial bus (USB) type system, an IEEE 1394 type system, or the like, to couple one or more peripheral devices to information handling system 500. Bus system 526 may comprise one or more bus systems such as a peripheral component interconnect (PCI) express type bus or the like, to connect one or more peripheral devices to information handling system 500. A hard disk drive (HDD) controller system 528 may couple one or more hard disk drives or the like to information handling system, for example Serial ATA type drives or the like, or alternatively a semiconductor based drive comprising flash memory, phase change, and/or chalcogenide type memory or the like. Switch 530 may be utilized to couple one or more switched devices to I/O bridge 522, for example Gigabit Ethernet type devices or the like. Furthermore, as shown in FIG. 5, information handling system 500 may include a radio-frequency (RF) block 532 comprising RF circuits and devices for wireless communication with other wireless communication devices and/or via wireless networks such as network 100 of FIG. 1, for example where information handling system 500 embodies base station 114 and/or subscriber station 116, although the scope of the claimed subject matter is not limited in this respect. In one or more embodiments, RF block 532 may comprise system 200 of FIG. 2, at least in part. Furthermore, at least some portion of system 200 may be implemented by processor 510, for example one or more of the logic circuits of system 200 which may include link statistics logic circuit 216, HARQ process logic circuit 218, and/or error detection and correction logic circuit 220, although the scope of the claimed subject matter is not limited in this respect.

Although the claimed subject matter has been described with a certain degree of particularity, it should be recognized that elements thereof may be altered by persons skilled in the art without departing from the spirit and/or scope of claimed subject matter. It is believed that the subject matter pertaining to selective hybrid ARQ and/or many of its attendant utilities will be understood by the forgoing description, and it will be apparent that various changes may be made in the form, construction and/or arrangement of the components thereof without departing from the scope and/or spirit of the claimed subject matter or without sacrificing all of its material advantages, the form herein before described being merely an explanatory embodiment thereof, and/or further without providing substantial change thereto. It is the intention of the claims to encompass and/or include such changes.

What is claimed is:

1. A method, comprising:
determining if a received packet was received with error;
if the packet was received with error:
updating link statistics based at least in part on said determining if the packet was received with error to provide updated link statistics;
determining if the updated link statistics exceed a predetermined threshold; and
if the updated link statistics exceed the predetermined threshold, executing a HARQ process.

2. A method as claimed in claim 1, further comprising:
if the packet was not received with error:
updating link statistics based at least in part on said determining if the packet was received with error to provide updated link statistics; and
optionally not executing a HARQ process.

3. A method as claimed in claim 1, wherein said determining if the updated link statistics exceed a predetermined threshold comprises comparing an updated shorter term packet error rate statistic to a threshold shorter term packet error rate statistic.

4. A method as claimed in claim 1, wherein said determining if the updated link statistics exceed a predetermined threshold comprises comparing an updated longer term packet error rate statistic to a threshold longer term packet error rate statistic.

5. A method as claimed in claim 1, wherein said determining if the updated link statistics exceed a predetermined threshold comprises determining if an updated shorter term packet error rate statistic is greater than or equal to a threshold shorter term packet error rate statistic, and if so then sending a negative acknowledgment packet and executing a HARQ process.

6. A method as claimed in claim 1, wherein said determining if the updated link statistics exceed a predetermined threshold comprises determining if an updated shorter term packet error rate statistic is greater than or equal to a threshold shorter term packet error rate statistic, or determining whether an updated longer term packet error rate statistic is greater than or equal to a threshold longer term packet error rate statistic, or combinations thereof, and if either being true then sending a negative acknowledgment packet and executing a HARQ process.

7. A method as claimed in claim 1, wherein said determining if the updated link statistics exceed a predetermined threshold comprises determining if an updated shorter term packet error rate statistic is greater than or equal to a threshold shorter term packet error rate statistic, or determining whether an updated longer term packet error rate statistic is greater than or equal to a threshold longer term packet error rate statistic, or combinations thereof, and if both being false then discarding the packet, sending an acknowledgment packet, and waiting for a next packet.

8. A method as claimed in claim 1, wherein the predetermined threshold is set to a value less than a maximum shorter term packet error rate.

9. A method as claimed in claim 1, wherein the predetermined threshold is set to a value less than a maximum longer term packet error rate.

10. A method as claimed in claim 1, wherein the predetermined threshold value is set based at least in part on one or more requirements of an application to receive the received packet.

11. A transceiver, comprising:
a physical layer and a link layer coupled with the physical layer, the link layer comprising:
an error detection and correction logic circuit;
a HARQ process logic circuit; and
a link statistics logic circuit coupled to the error detection and correction logic circuit and the HARQ process logic circuit, the link statistics logic circuit being capable of:
determining if a received packet was received with error;
if the packet was received with error:
updating link statistics based at least in part on said determining if the packet was received with error to provide updated link statistics;
determining if the updated link statistics exceed a predetermined threshold; and
if the updated link statistics exceed the predetermined threshold, executing a HARQ process.

12. A transceiver as claimed in claim 11, the link statistics logic circuit being further capable of:
if the packet was not received with error:
updating link statistics based at least in part on said determining if the packet was received with error to provide updated link statistics; and
optionally not executing a HARQ process.

13. A transceiver as claimed in claim 11, wherein said determining if the updated link statistics exceed a predetermined threshold comprises comparing an updated shorter term packet error rate statistic to a threshold shorter term packet error rate statistic.

14. A transceiver as claimed in claim 11, wherein said determining if the updated link statistics exceed a predetermined threshold comprises comparing an updated longer term packet error rate statistic to a threshold longer term packet error rate statistic.

15. A transceiver as claimed in claim 11, wherein said determining if the updated link statistics exceed a predetermined threshold comprises determining if an updated shorter term packet error rate statistic is greater than or equal to a threshold shorter term packet error rate statistic, and if so then sending a negative acknowledgment packet and executing a HARQ process.

16. A transceiver as claimed in claim 11, wherein said determining if the updated link statistics exceed a predetermined threshold comprises determining if an updated shorter term packet error rate statistic is greater than or equal to a threshold shorter term packet error rate statistic, or determining whether an updated longer term packet error rate statistic is greater than or equal to a threshold longer term packet error rate statistic, or combinations thereof, and if either being true then sending a negative acknowledgment packet and executing a HARQ process.

17. A transceiver as claimed in claim 11, wherein said determining if the updated link statistics exceed a predetermined threshold comprises determining if an updated shorter term packet error rate statistic is greater than or equal to a threshold shorter term packet error rate statistic, or determining whether an updated longer term packet error rate statistic is greater than or equal to a threshold longer term packet error rate statistic, or combinations thereof, and if both being false then discarding the packet, sending an acknowledgment packet, and waiting for a next packet.

18. A transceiver as claimed in claim 11, wherein the predetermined threshold is set to a value less than a maximum shorter term packet error rate.

19. A transceiver as claimed in claim 11, wherein the predetermined threshold is set to a value less than a maximum longer term packet error rate.

20. A transceiver as claimed in claim 11, wherein the predetermined threshold value is set based at least in part on one or more requirements of an application to receive the received packet.

21. A system, comprising:
a baseband processor, a transceiver coupled to the baseband processor, and an omnidirectional antenna coupled to the transceiver, wherein the transceiver comprises a physical layer and a link layer coupled with the physical layer, the link layer comprising:
an error detection and correction logic circuit, a HARQ process logic circuit, and a link statistics logic circuit coupled to the error detection and correction logic circuit and the HARQ process logic circuit, the link statistics logic circuit being capable of:
determining if a received packet was received with error;
if the packet was received with error:
updating link statistics based at least in part on said determining if the packet was received with error to provide updated link statistics;
determining if the updated link statistics exceed a predetermined threshold; and
if the updated link statistics exceed the predetermined threshold, executing a HARQ process.

22. A system as claimed in claim 21, the link statistics logic circuit being further capable of:
if the packet was not received with error:
updating link statistics based at least in part on said determining if the packet was received with error to provide updated link statistics; and
optionally not executing a HARQ process.

23. A system as claimed in claim 21, wherein said determining if the updated link statistics exceed a predetermined threshold comprises comparing an updated shorter term packet error rate statistic to a threshold shorter term packet error rate statistic.

24. A system as claimed in claim 21, wherein said determining if the updated link statistics exceed a predetermined threshold comprises comparing an updated longer term packet error rate statistic to a threshold longer term packet error rate statistic.

25. A system as claimed in claim 21, wherein said determining if the updated link statistics exceed a predetermined threshold comprises determining if an updated shorter term packet error rate statistic is greater than or equal to a threshold shorter term packet error rate statistic, and if so then sending a negative acknowledgment packet and executing a HARQ process.

26. A system as claimed in claim 21, wherein said determining if the updated link statistics exceed a predetermined threshold comprises determining if an updated shorter term packet error rate statistic is greater than or equal to a threshold shorter term packet error rate statistic, or determining whether an updated longer term packet error rate statistic is greater than or equal to a threshold longer term packet error rate statistic, or combinations thereof, and if either being true then sending a negative acknowledgment packet and executing a HARQ process.

27. A system as claimed in claim 21, wherein said determining if the updated link statistics exceed a predetermined threshold comprises determining if an updated shorter term packet error rate statistic is greater than or equal to a threshold shorter term packet error rate statistic, or determining whether an updated longer term packet error rate statistic is greater than or equal to a threshold longer term packet error rate statistic, or combinations thereof, and if both being false then discarding the packet, sending an acknowledgment packet, and waiting for a next packet.

28. A system as claimed in claim 21, wherein the predetermined threshold is set to a value less than a maximum shorter term packet error rate.

29. A system as claimed in claim 21, wherein the predetermined threshold is set to a value less than a maximum longer term packet error rate.

30. A system as claimed in claim 21, wherein the predetermined threshold value is set based at least in part on one or more requirements of an application to receive the received packet.
